(19) United States
(12) Patent Application Publication
(10) Pub. No.: US 2006/0181689 A1
(43) Pub. Date: Aug. 17, 2006

(54) Lithographic-optical systems including isolatable vacuum chambers, and lithography apparatus comprising same

(75) Inventors: Alton H. Phillips, East Palo Alto, CA (US); Douglas C. Watson, Campbell, CA (US); Hiroyuki Kondo, Kanagawa (JP)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 11/190,119

(22) Filed: Jul. 25, 2005

Related U.S. Application Data
(60) Provisional application No. 60/653,050, filed on Feb. 14, 2005.

(51) Int. Cl. G03B 27/42

(52) U.S. Cl. 355/53

(57) ABSTRACT

An exemplary optical system includes a first vacuum chamber and a second vacuum chamber having first and second portions. The first vacuum chamber contains an energy-beam source. The first vacuum-chamber portion contains a first optical-system portion that receives the beam from the source, and the second vacuum-chamber portion contains a second optical-system portion that receives the beam from the first optical-system portion. A first gate valve separates the first vacuum chamber and the first vacuum-chamber portion and provides, when open, communication between the first vacuum chamber and the first vacuum-chamber portion and a propagation pathway for the beam from the energy-beam source to the first optical-system portion. A second gate valve separates the first vacuum-chamber portion and the second vacuum-chamber portion and provides, when open, communication between the first vacuum-chamber portion and the second vacuum-chamber portion and a propagation pathway for the beam from the first optical-system portion to the second optical-system portion. The gate valves, when closed, allow pressure in the first vacuum-chamber portion to be changed without altering the pressures in the first vacuum chamber and the second vacuum-chamber portion.

### FIELD

This disclosure pertains, inter alia, to microlithography, which is a key imaging technology used in the formation of circuit layers in semiconductor integrated circuits, displays, memory devices, and the like. Another aspect of the disclosure pertains to microlithography systems employing, for imaging purposes, a wavelength of electromagnetic radiation that must propagate in a subatmospheric (“vacuum”) environment to avoid significant scattering and attenuation of the electromagnetic radiation. Yet another aspect of the disclosure pertains to microlithography systems utilizing extreme ultraviolet (EUV) light (also termed “soft X-ray” light) for imaging purposes.

### BACKGROUND

Microlithography involves the “transfer” of a pattern, having extremely small features, from a pattern-defining object to an imprintable object. In “projection-microlithography” the pattern-defining object is usually termed a “reticle” or “mask,” and the imprintable object is termed a “substrate,” which usually is a semiconductor wafer that may or may not already have previously formed circuit layers on its surface. So as to be imprintable with an image, the substrate is coated with a radiation-sensitive composition termed a “resist.”

Projection-microlithography systems are used extensively, for example, for manufacturing integrated circuits, microprocessors, memory “chips,” and the like. These products characteristically comprise multiple functional layers of microscopic circuit elements, all interconnected together in 3-dimensional space. Typically, microlithography is used for patterning most, if not all, the functional layers. In each microlithographic step, the pattern-defining object (usually a mask or reticle) defines the respective pattern for the particular functional layer to be formed. A beam of exposure radiation, termed an “illumination beam,” is produced by a radiation source and directed by an “illumination-optical system” from the source to the pattern-defining object. Interaction of the illumination beam with the pattern-defining object (i.e., selective transmission of the illumination beam through the pattern-defining object or selective reflection of the illumination beam from the pattern-defining object) results in patterning of the beam (now termed a “patterned beam” or “imaging beam”), which renders the patterned beam capable of forming an aerial image of the illuminated pattern. The patterned beam is projected by a “projection-optical system” onto a desired location on the resist-coated substrate where an actual image of the illuminated pattern is formed. Thus, a projection-microlithography system is a type of camera that projects and forms an image on the resist-coated substrate (analogous to a sheet of photographic paper) corresponding to the pattern defined by the pattern-defining object (analogous to a photographic negative, for example). For simplicity herein, the pattern-defining object is generally termed a “reticle.”

For exposure, the reticle usually is held on a device called a “reticle stage,” and the substrate usually is held on a device called a “substrate stage.” These stages also are typically equipped to perform highly accurate positional measurements and positioning in response to the measurements. Some microlithography systems have multiple reticle stages and/or multiple substrate stages which allow, for example, pre-exposure or post-exposure manipulations to be performed on other reticles and substrates, respectively, as an exposure is being performed on a particular substrate.

Before being exposed, and to prepare the substrate for exposure, the substrate is usually primed and then coated with a layer of a suitable resist. Before actual exposure, the resist usually is treated such as by a soft-bake step (“pre-exposure bake”). After exposure, the substrate may be soft-baked again (“post-exposure bake”), followed by development of the resist and a hard-bake step to prepare the resist for downstream process steps such as etching, doping, metallization, oxidation, or other suitable step in which the remaining resist on the substrate surface serves as a process mask. Thus, the respective layer is formed on the substrate. As noted above, multiple layers must be formed on the substrate in order to fabricate actual semiconductor devices, so these or similar process steps usually need to be repeated multiple times during the fabrication of the devices. During formation of each layer, steps must be taken to ensure proper and accurate registration of the new layer with the previously formed layer(s).

The substrate usually is sufficiently large to allow formation of multiple semiconductor devices at respective locations (“dies”) on the substrate. Exposure of multiple dies on the substrate can be die-to-die in one shot per die (characteristic of a “step-and-repeat” exposure scheme) or by scanning each die (characteristic of a “step-and-scan” exposure scheme). In step-and-scan each die typically is exposed by scanning in a scanning direction, wherein both the reticle and the substrate are moved during scanning. Movements of the reticle and substrate can be in the same direction or in opposite directions. If the projection-optical system has a magnification factor (M) other than unity, then the scanning velocity of the substrate typically is usually M times the scanning velocity of the reticle.

After completing the fabrication of all the required layers on the surface of the substrate, the dies are cut one from the other. Individual dies are mounted on a packaging substrate, connected to pins or the like, and encased to form finished semiconductor devices. The finished devices typically undergo rigorous testing before being released for sale.

Accompanying the acknowledgement of an apparent limit (not yet defined) of the minimum feature size of a pattern that can be transferred with acceptable resolution by optical microlithography, a substantial ongoing effort currently is being directed to the development of a practical “next-generation lithography” (“NGL”) technology. One promising NGL approach is EUV lithography (“EUVL”) performed generally in the wavelength range of 5-20 nm and more specifically at a wavelength in the range of approximately 11-14 nm.

One challenge posed by EUVL is the substantial scattering and attenuation of an EUV beam by normal-pressure air. Consequently, the propagation path of an EUV beam in an EUVL system must be maintained at high vacuum. Another challenge posed by EUVL is the lack of any known material that is both EUV-transmissive and capable of refracting EUV light. Consequently, all the optical elements in an EUV optical system must be reflective rather than refractive. These reflective optical systems and elements include the illumination-optical system, the projection-optical system, and the reticle itself.

The respective reflective elements making up the reticle, the illumination-optical system, and the projection-optical system of an EUVL system must be fabricated extremely accurately to obtain the level of optical performance currently being demanded. The elements also must perform their intended functions without exhibiting any significant degradation of performance caused, for example, by repeated or prolonged exposure to the EUV radiation and/or by accumulation of dust, other debris, and/or contamination on the reflective surfaces of the elements.

Yet another challenge posed by EUVL is the source of the EUV light. A particularly suitable source is an EUV beam produced by a synchrotron, undulator, or analogous device. But, synchrotrons and undulators are very large, enormously expensive, and enormously complex devices, and very few semiconductor-fabrication facilities have access to a synchrotron. Other EUV sources have been developed, including discharge-plasma and laser-plasma sources. These sources produce EUV radiation from a plasma generated from a target material by electrical discharges or laser irradiation, respectively. Whereas these other sources are advantageously compact and relatively portable (compared to a synchrotron), they unfortunately produce from the target material substantial amounts of debris that tends to become deposited on the optical elements especially of the illumination-optical system. This debris and the need to remove it periodically pose a substantial maintenance problem with respect to optical components located in the EUV source itself and in neighboring systems.

Also, the plasma is very hot, and the light produced by the plasma is very intense; this combination of elevated temperature and illumination intensity can deteriorate nearby surfaces. For example, plasma-based EUV sources typically include a collector mirror in close proximity to the plasma. The collector mirror tends to experience a rapid rate of debris accumulation and corrosion from the plasma as well as deterioration caused by high temperature and intense illumination. As a result, the collector mirror requires frequent maintenance (e.g., cleaning or replacement), which involves a substantial interruption in the operation of the EUVL system.

Generally, the closer a mirror is to the plasma, the more rapid the rate of contamination and corrosion of the mirror by plasma debris. Hence, the mirrors in the illumination-optical system also become contaminated during use. Aside from the plasma, other sources of contamination are other components (e.g., mechanical components that move) situated in the vacuum chamber with the mirrors, and the vacuum pumps used for evacuating the vacuum chamber. Debris accumulation, contamination, and corrosion of EUV optical elements are substantial problems because these phenomena cause substantial reductions in reflectivity (and thus optical performance) of the elements. Unfortunately, whenever the time for a maintenance event arrives, the EUV system must be shut down, the vacuum must be vented, and the optical systems opened up to remove the element(s) requiring maintenance. After cleaning, repair, or replacement of the element(s), the optical system(s) must be reassembled and aligned, the optical systems closed and evacuated, and the system recalibrated to restore the system to normal operational status. These various maintenance-related tasks consume enormous amounts of time and thus impose substantial detriments to system throughput. Thus, these maintenance tasks must be performed quickly, without contaminating the system and without harming other parts of the system.

Unfortunately, debris accumulation in an EUVL system tends to be rapid, especially of components located relatively near to the plasma. Consequently, current EUVL systems must be shut down frequently for optical-maintenance tasks such as mirror cleaning and/or replacement. These frequent shut-downs cause substantial decreases in overall throughput of the equipment. In a modern semiconductor-fabrication facility where EUVL systems would be used, throughput is a key determinant of whether the facility is or can be economically viable.

### SUMMARY

According to a first aspect, among various aspects of the invention, optical systems for lithographic exposure apparatus are provided. An embodiment of such a system comprises a vacuum chamber having a first vacuum-chamber portion and a second vacuum-chamber portion. A first optical-system portion is contained in the first vacuum-chamber portion, a second optical-system portion is contained in the second vacuum-chamber portion, and a vacuum gate valve separates the first and second vacuum-chamber portions. In this embodiment the vacuum gate valve (as defined herein) provides a closable passageway between the first and second vacuum-chamber portions that, when open, allows communication between the first and second vacuum-chamber portions and allows an energy beam to pass from the first optical-system portion to the second optical-system portion via the vacuum gate valve, and that, when closed, allows the pressure in the first vacuum-chamber portion to be changed without altering the pressure in the second vacuum chamber portion. The system further can comprise an access port in the first vacuum-chamber portion that allows access, from outside the vacuum chamber, to inside the first vacuum-chamber portion. The access port can be configured to allow passage therethrough of an optical component of the first optical-system portion. By way of example, the first optical-system portion can include an optical component requiring periodic maintenance, wherein the access port is configured to allow the optical component to be removed from the first vacuum-chamber portion for performance of a maintenance activity on the optical component.

The system further can comprise a third vacuum-chamber portion and a second vacuum gate valve separating the first and third vacuum-chamber portions. In this embodiment the second vacuum gate valve provides a closable passageway between the first and third vacuum-chamber portions that, when open, allows communication between the first and third vacuum-chamber portions and allows the energy beam to propagate from the third vacuum-chamber portion to the first optical-system portion via the second vacuum gate valve. When closed, the second vacuum gate valve allows the pressure in the first vacuum-chamber portion to be changed without altering the pressure in the third vacuum chamber portion. The third vacuum-chamber portion can contain, for example, an energy-beam source. The system further can comprise an access port in the first vacuum-chamber portion that allows access, from outside the vacuum chamber, to inside the first vacuum-chamber portion. The first optical-system portion can include an optical component that receives the energy beam from the energy-beam source under a condition in which the optical component requires periodic maintenance. The access port can be configured to allow the optical component to be removed from the first vacuum-chamber portion for performance of a maintenance activity on the optical component.

The first and second optical-system portions can operate in a high-vacuum environment established in the first and second vacuum-chamber portions as well as in the third vacuum-chamber portion. In this embodiment the vacuum gate valves, when closed, allow the first vacuum-chamber portion to be vented to atmospheric pressure while preserving the high-vacuum environment in the second and third vacuum-chamber portions.

The first and second vacuum gate valves can be configured to allow detachment of the first vacuum-chamber portion from the second and third vacuum-chamber portions. For example, the first and second gate valves can be provided with vacuum flanges or analogous means by which the first vacuum-chamber portion is removably attached to the gate valves.

If the first and second optical-system portions operate in a high-vacuum environment established in the first and second vacuum-chamber portions, respectively, then the vacuum gate valve can be configured such that, when the valve is closed, the first vacuum-chamber portion can be vented to atmospheric pressure while preserving the high-vacuum environment in the second vacuum-chamber portion.

In an exemplary system the energy beam is an EUV beam and the optical system is an illumination-optical system. In such a system the first and second optical-system portions can comprise respective EUV-reflective optical elements of the illumination-optical system.

According to another aspect, lithographic exposure apparatus are provided that comprise an optical system such as any of the systems summarized above.

According to another aspect, optical systems are provided for lithographic systems that perform lithographic exposures using an energy beam propagating in a vacuum environment. An embodiment of such an optical system comprises a vacuum chamber having a first vacuum-chamber portion, a second vacuum-chamber portion, and a third vacuum-chamber portion. An energy-beam source is contained in the third vacuum-chamber portion. A first optical-system portion is contained in the first vacuum-chamber portion and is configured to receive the energy beam from the energy-beam source. A second optical-system portion is contained in the second vacuum-chamber portion and is configured to receive the energy beam from the first optical-system portion. A first vacuum gate valve separates the first and third vacuum-chamber portions and provides, when open, communication between the first and third vacuum-chamber portions and a propagation pathway for the energy beam from the energy-beam source to the first optical-system portion. A second vacuum gate valve separates the first and second vacuum-chamber portions and provides, when open, communication between the first and second vacuum-chamber portions and a propagation pathway for the energy beam from the first optical-system portion to the second optical-system portion. The first and second vacuum gate valves, when closed, allow the pressure in the first vacuum-chamber portion to be changed without altering the respective pressures in the second and third vacuum-chamber portions. The first vacuum-chamber portion can comprise an access port allowing access to the first optical-system portion including whenever the first and second vacuum gate valves are closed.

By way of example, the optical system can be an illumination-optical system for an extreme ultraviolet (EUV) lithography system. In an embodiment of such a system, the illumination-optical system comprises multiple EUV-reflective mirrors, and the first optical-system portion comprises a collimator mirror of the illumination-optical system. The second optical-system portion comprises at least one fly-eye mirror, and the second optical-system portion further can comprise at least one condenser mirror.

An embodiment of the optical system further can comprise a fourth vacuum-chamber portion. A third optical-system portion can be situated in the fourth vacuum-chamber portion and configured to receive the energy beam from the second optical-system portion. A third vacuum gate valve can be used for separating the second and fourth vacuum-chamber portions, wherein the third vacuum gate valve provides, when open, communication between the second and fourth vacuum-chamber portions and a propagation pathway for the energy beam from the second optical-system portion to the third optical-system portion. The second optical-system portion can comprise at least one fly-eye mirror, and the third optical-system portion can comprise at least one condenser mirror. In addition, each of the first, second, and fourth vacuum-chamber portions can include a respective access port allowing access to the respective optical-system portion including whenever the respective vacuum gate valves are closed.

Another embodiment of a optical system for a lithographic system (that performs lithographic exposures using an energy beam propagating in a vacuum environment) comprises first and second vacuum chambers, wherein the second vacuum chamber has a first vacuum-chamber portion and a second vacuum-chamber portion. An energy-beam source is contained in the first vacuum chamber. A first optical-system portion is contained in the first vacuum-chamber portion and is configured to receive the energy beam from the energy-beam source. A second optical-system portion is contained in the second vacuum-chamber portion and is configured to receive the energy beam from the first optical-system portion. A first vacuum gate valve separates the first vacuum chamber and the first vacuum-chamber portion and provides, when open, communication between the first vacuum chamber and the first vacuum-chamber portion and a propagation pathway for the energy beam from the energy-beam source to the first optical-system portion. A second vacuum gate valve separates the first vacuum-chamber portion and the second vacuum-chamber portion and provides, when open, communication between the first vacuum-chamber portion and the second vacuum-chamber portion and a propagation pathway for the energy beam from the first optical-system portion to the second optical-system portion. When the first and second vacuum gate valves are closed, the pressure in the first vacuum-chamber portion can be changed without altering the respective pressures in the first vacuum chamber and the second vacuum-chamber portion. The first vacuum chamber can contain an energy-beam source, wherein the first optical-system portion comprises a first portion of an illumination-optical system of the lithographic system. In this configuration the second optical-system portion can comprise a second portion of the illumination-optical system.

In a system as summarized above the first optical-system portion can comprise an optical element requiring periodic maintenance consequential to the optical element being located proximally, via the first vacuum gate valve, to the energy-beam source. The first optical-system portion can comprise an access port allowing access to the optical element for maintenance at times including whenever the first and second vacuum gate valves are closed.

According to another aspect, illumination-optical systems (IOSs) for an extreme-UV (EUV) lithography system are provided. An embodiment of such an IOS comprises a source chamber and a vacuum chamber. The vacuum chamber has a first vacuum-chamber portion and a second vacuum-chamber portion. An EUV-beam source that produces an illumination beam is contained in the source chamber. A first IOS portion is contained in the first vacuum-chamber portion and is configured to receive the illumination beam from the EUV-beam source. A second IOS portion is contained in the second vacuum-chamber portion and is configured to receive the illumination beam from the first IOS portion. A first vacuum gate valve separates the source chamber and the first vacuum-chamber portion and provides, when open, communication between the source chamber and the first vacuum-chamber portion and a propagation pathway for the illumination beam from the EUV-beam source to the first IOS portion. A second vacuum gate valve separates the first vacuum-chamber portion and the second vacuum-chamber portion and provides, when open, communication between the first vacuum-chamber portion and the second vacuum-chamber portion and a propagation pathway for the illumination beam from the first IOS portion to the second IOS portion. The first and second vacuum gate valves, when closed, allow the pressure in the first vacuum-chamber portion to be changed without altering the respective pressures in the source chamber and the second vacuum-chamber portion. By way of example, the EUV-beam source is a plasma-based EUV source, and the first IOS portion comprises a collimator mirror that collimates the illumination beam from the EUV source. In this example, the second IOS portion can comprise at least one fly-eye mirror and at least one condenser mirror, wherein the illumination beam propagates from the EUV source, through the first IOS portion, and through the second IOS portion to a reticle. The first vacuum-chamber portion can comprise an access port allowing access to the first IOS portion for maintenance at times including whenever the first and second vacuum gate valves are closed. Also, the first vacuum-chamber portion can be detachable from the first and second vacuum gate valves.

Also provided are EUV lithography systems that comprise an illumination-optical system such as any of the illumination-optical systems summarized above.

Another embodiment of an optical system for a lithographic exposure apparatus comprises first vacuum-chamber means for containing a first optical-system portion at a respective vacuum level, second vacuum-chamber means for containing a second optical-system portion at a respective vacuum level, and gate means for separating the first and second vacuum-chamber means, for providing a closable passageway between the first and second vacuum-chamber means, and for providing, when open, communication between the first and second vacuum-chamber means and a beam trajectory from the first optical-system portion via the gate means to the second optical-system portion. The gate means further can provide, when closed, isolation of the first vacuum-chamber means from the second vacuum-chamber means that allows pressure in the first vacuum-chamber means to be changed without altering pressure in the second vacuum-chamber means.

According to yet another aspect, and in the context of a lithographic exposure apparatus having an optical system contained in a vacuum chamber and having a first optical-system portion and a second optical-system portion, methods are provided for isolating the first optical-system portion relative to the second optical-system portion to allow maintenance access to the first optical-system portion. An embodiment of such a method comprises situating the first optical-system portion in a first vacuum-chamber portion and situating a second optical-system portion in a second vacuum-chamber portion that is separated from the first vacuum-chamber portion by a vacuum gate valve that, when open, allows the energy beam to propagate through the open valve from the first optical-system portion to the second optical-system portion. The method further includes closing the vacuum gate valve and, without significantly altering pressure in the second vacuum-chamber portion, venting the first vacuum-chamber portion to a pressure allowing the first vacuum-chamber portion to be opened. While keeping the vacuum gate valve closed, the first vacuum-chamber portion is opened to gain maintenance access to the first optical-system portion without significantly changing pressure in the second optical-system portion.

According to yet another aspect, and in the context of an extreme-UV (EUV) lithography apparatus having an EUV-optical system including a first optical-system portion to which access must be gained from time to time, methods are provided for isolating the first optical-system portion relative to a second optical-system portion to allow access to the first optical-system portion. An embodiment of such a method comprises situating the first optical-system portion in a vacuum-chamber portion that is separated from an upstream chamber by a first vacuum gate valve that, when open, allows an EUV beam to propagate through the open valve from the upstream chamber to the first optical-system portion. The second optical-system portion is situated in a downstream chamber that is separated from the vacuum-chamber portion by a second vacuum gate valve that, when open, allows an EUV beam to propagate through the open valve from the first optical-system portion to the second optical-system portion. In another step the first and second vacuum gate valves are closed and, without significantly altering pressure in the upstream and downstream chambers, the vacuum-chamber portion is vented to a pressure allowing opening of the vacuum-chamber portion. While keeping the vacuum gate valves closed, the vacuum-chamber portion is opened to gain access to the first optical-system portion without significantly changing pressure in the upstream and downstream chambers. The upstream chamber can contain, for example, an EUV-beam source, wherein the EUV-optical system is an illumination-optical system comprising multiple EUV-reflective mirrors. The first optical-system portion can comprise an EUV-reflective mirror that is most proximal to the EUV-beam source. The most proximal EUV-reflective mirror can be, for example, a collimator mirror.

The foregoing and additional features and advantages of the various embodiments will be more apparent from the following detailed description, which proceeds with reference to the accompanying drawings.

### BRIEF DESCRIPTION OF THE DRAWINGS

FIG. 1 is a schematic elevational diagram of an extreme UV lithography (“EUVL”) system showing pertinent major structures, the illumination-optical system, and the EUV source.

FIG. 2 is an elevational view of an exemplary illumination-unit (“IU”) frame to which are attached the mirrors of the illumination-optical system of an EUVL system embodiment.

FIG. 3 is a schematic elevational diagram of an EUVL system, according to a representative embodiment, in which the collimator lens of the illumination-optical system is contained in a respective vacuum chamber that can be isolated from the remainder of the illumination-optical system and the EUV source by respective vacuum gate valves.

FIG. 4 is a schematic elevational diagram of certain features of the first representative embodiment.

FIG. 5 is a schematic diagram of the illumination-optical system of an EUVL system according to a second representative embodiment in which other mirror(s) of the illumination-optical system can be contained in respective isolatable vacuum chambers.

FIG. 6 is a block diagram of an exemplary semiconductor-device fabrication process that includes wafer-processing steps comprising a microlithography step performed using a microlithography system as described herein.

FIG. 7 is a block diagram of a wafer-processing process as referred to in FIG. 6.

### DETAILED DESCRIPTION

This disclosure is set forth in the context of representative embodiments that are not to be regarded as limiting in any way. In addition, although the disclosure is set forth in the context of an extreme ultraviolet lithography (EUVL) system, it will be understood that the subject devices and methods are not limited to EUVL systems. For example, the subject devices and methods can be used in connection with other types of lithography equipment requiring that the constituent optical systems (illumination-optical system and/or projection-optical system) be contained in a vacuum chamber. Further alternatively, the subject devices and methods can be used in other types of equipment having respective optical systems that are contained in a vacuum chamber.

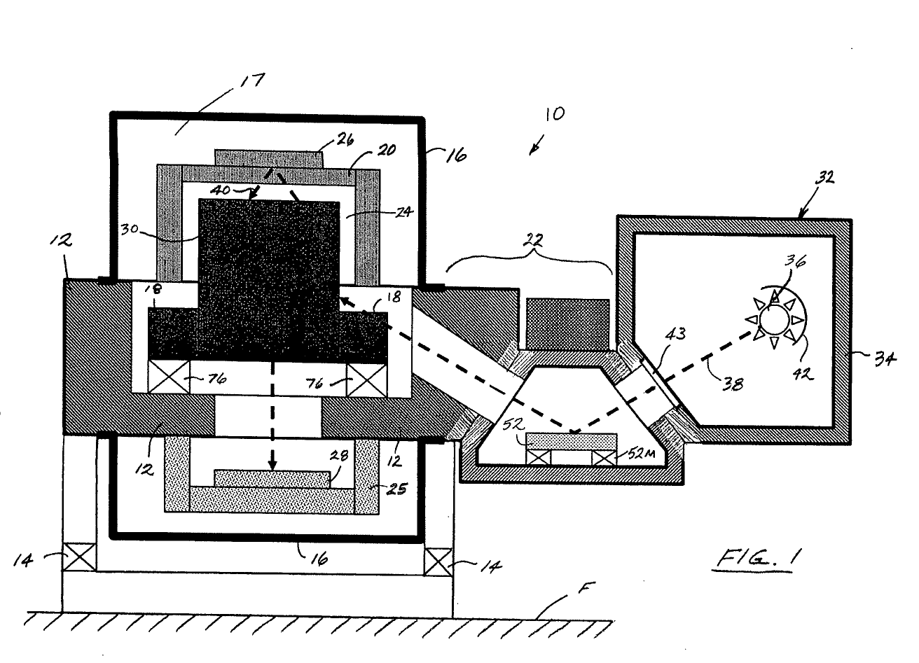

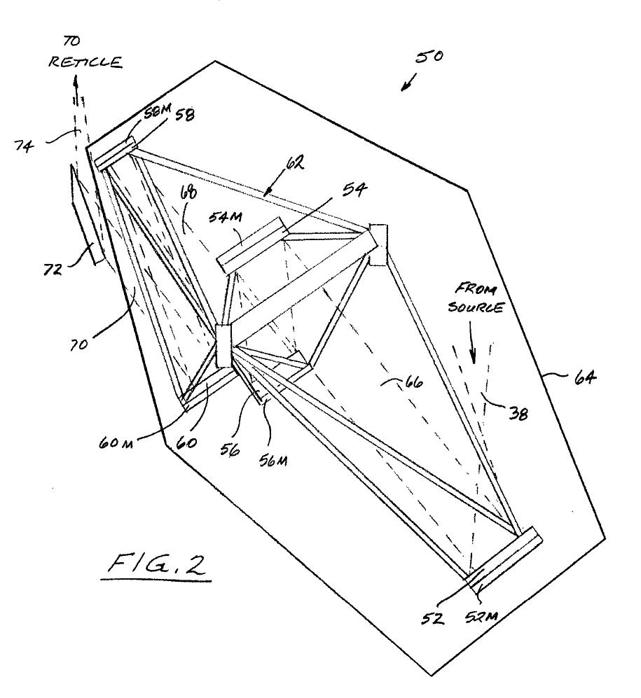

Certain aspects of an EUVL system 10 are shown in FIG. 1. The depicted system 10 includes a main frame 12 to which various other structures and assemblies are mounted. The main frame 12 is mounted to the floor F or analogous basal structure via mountings 14 that desirably provide active vibration isolation and other attenuation of vibrations. The main frame 12 defines at least a portion of a main vacuum chamber 17 for the EUVL system 10, wherein the main vacuum chamber 17 is also defined in part by walls 16. Rigidly mounted to the main frame 12 is a reticle-stage frame 20 to which a reticle stage 26 is mounted. Also mounted to the main frame 12 is an illumination-unit chamber (“IU chamber”) 22 that can include a frame (“IU frame”; not shown, but see FIG. 2) supporting at least some of the mirrors of the illumination-optical system. The reticle-stage frame 20 is located within the main vacuum chamber 17, which includes a projection-optics chamber 24. Also rigidly mounted to the main frame 12 is a wafer-stage frame 25 to which a wafer stage 28 is mounted. Situated within the projection-optics chamber 24, between the reticle stage 26 and wafer stage 28, is a projection-optics barrel (“POB”) 30 that is supported by a sub-frame 18. The POB 30 includes and supports the mirrors of the projection-optical system.

The EUV source 32 is situated in a respective chamber (“source chamber”) 34 that is connected to the IU chamber 22. The EUV source 22 produces pulses of EUV light from, for example, a laser-induced plasma 36 or electrical-discharge-induced plasma. The EUV light (illumination beam) 38 propagates from the EUV source 32 to the illumination-optical system, which shapes and conditions the illumination beam as required for illuminating the reticle. EUV light 40 (now patterned according to the portion of the reticle pattern illuminated by the illumination beam) reflected from the reticle propagates to the projection-optical system, which shapes and conditions the patterned beam as required for forming an image of the illuminated pattern on the surface of the resist-coated substrate (usually a semiconductor wafer). The reticle is mounted on the reticle stage 26, and the substrate is mounted on the wafer stage 28.

In the source chamber 34, light from the plasma 36 is reflected from a concave collector mirror 42, which gathers the light produced by the plasma and directs the collected light to the illumination-optical system. The EUV source 32 typically includes a filter 43 that removes, from the EUV light produced by the plasma 36, extraneous and unwanted wavelengths of light (including visible light) as the EUV light exits the source 32. Thus, the light exiting the EUV source consists almost exclusively of the particular wavelength (e.g., 13.4 nm) of EUV light desired for making lithographic exposures. The filter 43 typically is configured as a window of the source chamber 34.

Turning now to FIG. 2, an exemplary illumination-optical system 50 includes a collimator mirror 52, a first fly-eye mirror 54, a second fly-eye mirror 56, a first condenser mirror 58, and a second condenser mirror 60. These mirrors can be mounted to a rigid IU frame 62 in the IU chamber 64 (or alternatively the IU chamber 64 can function as a mirror “frame”) so as to place them in proper respective positions relative to each other. Each mirror 52, 54, 56, 58, 60 is mounted on a respective mounting 52M, 54M, 56M, 58M, 60M. The collimator mirror 52 collimates the EUV beam 38 from the EUV source 32 as the beam reflects from the collimator mirror. The collimated light 66 propagates to the first fly-eye mirror 54, from which the light reflects to the second fly-eye mirror 56. The first fly-eye mirror 54 typically is arc-shaped (corresponding approximately to the illumination field), and the second fly-eye mirror 56 typically has a rectangular profile. The fly-eye mirrors 54, 56 make the illumination intensity of the EUV light substantially uniform over the illumination field. From the second fly-eye mirror 56 the EUV light 68 assumes a gradually convergent characteristic as the EUV light propagates to and reflects from the first and second condenser mirrors 58, 60. From the second condenser mirror 60 the EUV light 70 reflects (at grazing incidence) from a grazing-incidence mirror 72 (usually a planar mirror) to the reticle where the illumination field illuminates respective selected portions of the reticle pattern at particular instances in time. Due to its proximity to the reticle, the grazing-incidence mirror 72 (even though part of the illumination-optical system) usually is mounted in the POB 30.

During illumination, the reticle is mounted (reflective-side facing downward) on a reticle chuck mounted on the reticle stage 26. The reticle stage 26 is movable to position the reticle chuck (and thus the reticle) as required for illumination of the desired portions of the reticle pattern by the illumination field at respective instances in time. Associated with the reticle stage 26 are metrology components (e.g., interferometers, not detailed) used for monitoring the position of the reticle with extremely high accuracy. The reticle stage 26 desirably is configured to perform adjustments of reticle position in multiple degrees of freedom of movement. Most desirably, reticle position is adjustable in all six degrees of freedom of motion (x, y, z, θₓ, θ_{y}, θ_{z}). See, e.g., U.S. Pat. Nos. 6,693,284 and 6,867,534 to Tanaka, both incorporated herein by reference.

The particular type of illumination-optical system shown in FIG. 2 is a 6-mirror system (including the grazing-incidence mirror 72). So as to be reflective to incident EUV light at less than grazing angles of incidence, the collimator mirror 52, fly-eye mirrors 54, 56, and condenser mirrors 58, 60 have surficial multilayer-interference coatings (e.g., multiple superposed and very thin layer pairs of Mo and Si) that render the surfaces of these mirrors reflective to incident EUV light. Due to the manner in which the EUV light reflects from the grazing-incidence mirror 72 (i.e., at grazing angles of incidence), the grazing-incidence mirror need not have a multilayer coating. In the EUV source 32, the concave collector mirror 42 also has a multilayer-interference coating.

The EUV light 74 from the grazing-incidence mirror 72 is incident on the reticle at a small angle of incidence (approximately 5 degrees). So as to be reflective to EUV light at such a small angle of incidence, the reticle also has a multilayer-interference coating as well as EUV-absorbent bodies that define, along with spaces between the bodies, the particular pattern on the reticle that is to be transferred to a substrate. Thus, as the EUV light reflects from the irradiated region of the reticle, the EUV light acquires an aerial image of the pattern on the reticle and thus is rendered capable of imaging the illuminated pattern on the surface of the substrate.

To form the image on the resist-coated surface of the substrate, the “patterned” EUV light reflected from the reticle passes through the projection-optical system in the POB 30. The projection-optical system also contains multiple reflective mirrors. Depending upon its particular configuration, the projection-optical system usually has two, four, or six mirrors each having a respective multilayer-interference coating. These mirrors are mounted in the POB 30 that provides a frame for the mirrors. The projection-optical system shapes and conditions the patterned beam as required to cause the patterned beam to form an image of the illuminated reticle portion on the surface of the resist-coated substrate mounted on the wafer stage.

During image formation thereon, the substrate is mounted (facing upward) on a wafer chuck that is mounted on the wafer stage 28. The wafer stage 28 positions the wafer chuck as required for illumination of the desired portions of the substrate surface by the patterned beam at respective instances in time. Associated with the wafer stage 28 are metrology components (e.g., interferometers, not detailed) used for monitoring the position of the wafer stage with extremely high accuracy. The wafer stage 28 desirably is configured to perform adjustments of substrate position in multiple degrees of freedom of movement. Most desirably, substrate position is adjustable in all six degrees of freedom of motion (x, y, z, θₓ, θ_{y}, θ_{z}). See, e.g., U.S. Pat. Nos. 6,693,284 and 6,867,534 to Tanaka, both incorporated herein by reference.

To ensure stability of the projection-optical system (required for optimal imaging performance), the POB 30 is mounted to the sub-frame 18, and the sub-frame 18 is mounted to the main frame 12 via mountings 76 that desirably provide active vibration isolation (AVIS) and other appropriate vibration attenuation of the POB relative to the main frame 12.

### First Representative Embodiment

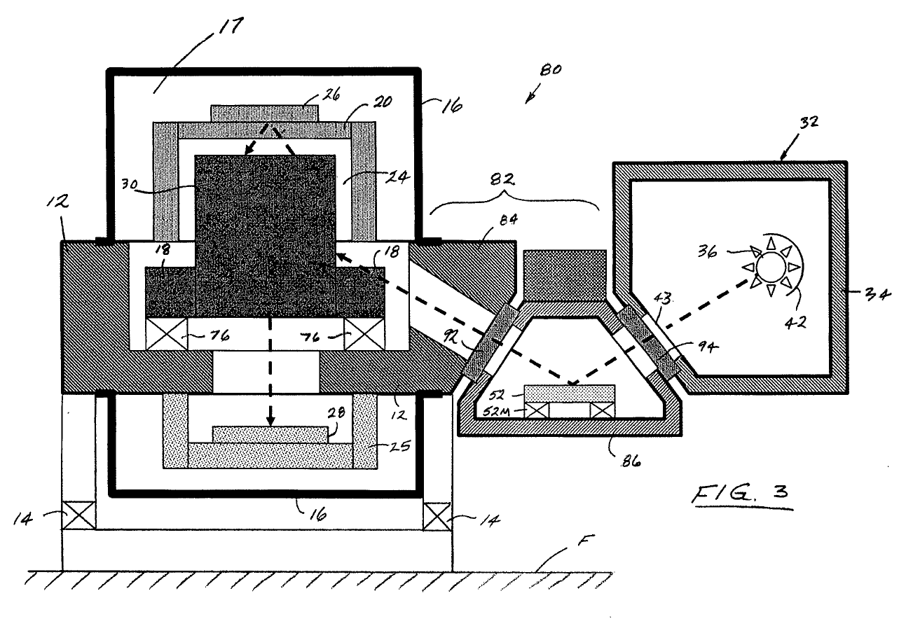

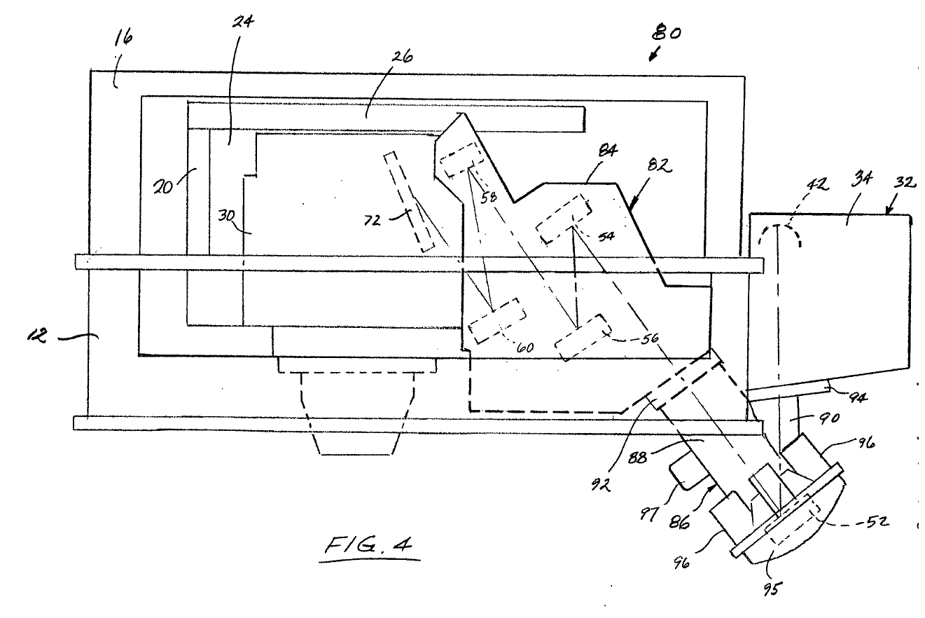

Referring to the EUVL-system embodiment 80 shown in FIGS. 3 and 4, the main frame 12, main vacuum chamber 17, sub-frame 18, reticle-stage frame 20, projection-optics chamber 24, POB 30, wafer-stage frame 25, reticle stage 26, wafer stage 28, and source chamber 34 are shown. The IU chamber 82 of this embodiment differs from the configuration shown in FIG. 1 by being divided into two portions: a first portion (termed the “FE/CON chamber” 84) containing the fly-eye mirrors 54, 56 and the condenser mirrors 58, 60, and a second portion (termed the “collimator chamber”) 86 containing the collimator mirror 52. Also, in this embodiment, the collimator chamber 86 and FE/CON chamber 84 function as respective “frames” for the collimator mirror 52 and other mirrors 54, 56, 58, 60, respectively, thereby eliminating the need for the IU frame 62. The collimator chamber 86 is interposed between the FE/CON chamber 84 and the source chamber 34. As described below, in the collimator chamber 86 the collimator mirror 52 is mounted via a kinematic mounting 52M that provides multiple degrees of freedom of movement of the collimator mirror relative to the collimator chamber so as to track downstream optics of the illumination-optical unit.

Turning now to FIG. 4, the collimator chamber 86 comprises a first arm 88 and a second arm 90 that are attached to the FE/CON chamber 84 and source chamber 34, respectively, via respective vacuum gate valves 92, 94. The collimator chamber 86 also includes a mounting-cell cover plate 95. The vacuum gate valves 92, 94 are actuatable to be either in an open position (the normal position during use of the illumination-optical system) or a closed position (the normal position for obtaining access to the collimator mirror 52). Closing both vacuum gate valves 92, 94 effectively isolates the interior of the collimator chamber 86 from the source chamber 34 and from the FE/CON chamber 84, which allows access to the interior of the collimator chamber 86 without disturbing or contaminating any of the other optical components of the EUVL system 80. In other words, upon closing the vacuum gate valves 92, 94, high vacuum can be retained in the main vacuum chamber 17 (including the FE/CON chamber 84) and in the source chamber 34 while the interior of the collimator chamber 86 is vented to atmospheric pressure.

As used herein, the term “vacuum gate valve” is not limited to appliances conventionally termed “vacuum gate valves,” but rather also encompasses any of various mechanisms operable to move a member (generally termed a “gate”) over an opening in a partition of the vacuum-chamber wall so as to provide a closable passage through the partition as well as provide, when in the closed position, an acceptable vacuum seal across the partition. The term “vacuum gate valve” also encompasses devices that operate manually in addition to devices that include respective actuators for opening and closing the “gate.”

Upon being brought to atmospheric pressure, the collimator chamber 86 can be opened (e.g., by removing the mounting-cell cover plate 95). In an advantageous embodiment, the collimator mirror 52 is mounted just inside the mounting-cell cover plate 95, so detaching the mounting-cell cover plate from the collimator chamber 86 presents the collimator mirror 52 for removal from the collimator chamber or for cleaning or adjustment in situ. Actual removal of the collimator mirror 52 is indicated for replacement, substantial cleaning, other maintenance, and other purposes. Meanwhile, because the vacuum gate valves 92, 94 are closed, the interiors of the main vacuum chamber 17, FE/CON chamber 84, and source chamber 34 can be maintained in an evacuated state. After performing the desired service to the collimator mirror 52, the mirror is re-mounted in the collimator chamber 86, the mounting-cell cover plate 95 is reattached, the desired vacuum is reestablished in the collimator chamber (by pump-down through the port 97), and the vacuum gate valves 92, 94 are re-opened to reestablish communication of the collimator chamber 86 with the rest of the EUVL system 80 and to re-open the light path from the EUV source 32 to the illumination-optical system.

Because the collimator chamber 86 is much smaller than the combined volume of the main vacuum chamber 17 and the interior of the FE/CON chamber 84, the collimator chamber 86 requires much less time than the main vacuum chamber and FE/CON chamber to pump down to the desired vacuum level. This, in turn, allows maintenance on the collimator mirror 52 to be performed in much less time than conventionally and without causing environmental contamination of the main vacuum chamber 17 or FE/CON chamber 84.

As noted, the collimator mirror 52 is mounted in the collimator chamber 86 using a mirror mount 52M that provides a desired number of degrees of freedom of adjustment of mirror motion, thereby allowing the collimator mirror 52 to track downstream IU optics in the FE/CON chamber 84. By way of example, a particularly desirable mounting is a “KALM” kinematic mounting that provides six degrees of freedom (x, y, z, θₓ, θ_{y}, θ_{z}) of positional adjustability of the mirror, as described in U.S. Published Patent Application No. U.S. 2002/0163741 A1, incorporated herein by reference. A KALM mounting can utilize any of various types of actuators, including but not limited to, piezoelectric (PZT) actuators with strain gauge, pico motors with encoder, stepper motors with micrometer (μmeter) and encoder, and voice-coil motors (VCM) with inductive sensor. As indicated by the housing extensions, the actuators desirably are located in the vacuum environment inside the collimator chamber 86 during use. To such end, referring to FIG. 4, the collimator chamber 86 includes housing extensions 96 that contain respective actuators. In addition to the full degrees of freedom offered by the KALM mounting, the collimator mirror 52 may also include mountings that either allow or constrain, for example, radial expansion of the collimator mirror. In addition to mountings, the collimator mirror 52 may also include a fluidic connection that facilitates circulation of a mirror-cooling fluid as required. Fluidic cooling of the mirror may be enhanced by providing the mirror with internal cooling passages for the fluid.

Similarly, inside the FE/CON chamber 84, the fly-eye mirrors 54, 56 and the condenser mirrors 58, 60 desirably are mounted using respective mirror mounts 54M, 56M, 58M, 60M. Vibration isolation of the mirrors 54, 56, 58, 60 is provided by the AVIS mountings 76 between the main frame 12 and the sub-frame 18. The mirror mounts 54M, 56M, 58M, 60M provide desired numbers of degrees of freedom of adjustment of mirror attitude. For example, each of the fly-eye mirrors 54, 56 can have full KALM mounts (each providing all six degrees of freedom), and the condenser mirrors can have partial KALM mounts (each providing less than all six degrees of freedom). The actuators providing adjustability can be in the vacuum environment inside the FE/CON chamber 84 or in the vacuum environment of the main vacuum chamber 17 during use. Certain or all these mirrors 54, 56, 58, 60 can include heat exchangers, depending upon their expected heat load and shape requirements. The heat exchangers can be passive or can include channels or the like for passage of a gaseous or liquid coolant. In addition, certain or all these mirrors can include mounting structure that constrains radial deformation.

The collimator chamber 86 also defines at least one vacuum port 97 to which a vacuum-pump system is connected for evacuating the collimator chamber. An exemplary vacuum-pump system includes a roughing pump (e.g., dry rotary vane or Roots pump) and a turbo-molecular pump.

Although the gates on vacuum gate valves are normally opaque, the gates on the vacuum gate valves 92, 94 need not be opaque. In an alternative configuration, the vacuum gate valves 92, 94 can be configured with respective optical windows (not shown) that allow the transmission of non-EUV radiation. Such a feature would allow, for example, re-alignment of the collimator mirror 52 with other portions of the EUVL optical system before commencing pump-down of the collimator chamber 86.

In an alternative configuration the collimator chamber 86 is actually detachable from the vacuum gate valves 92, 94, which remain behind on the FE/CON chamber 84 and source chamber 34, respectively. To such end, the arms 88, 90 of the collimator chamber 86 desirably are fitted with vacuum flanges or the like that mate to respective vacuum flanges on the vacuum gate valves 92, 94. In this configuration closing both vacuum gate valves 92, 94 effectively isolates the interior of the collimator chamber 86 from the source chamber 34 and from the FE/CON chamber 84 and allows the collimator chamber to be detached from the FE/CON chamber and source chamber while leaving the vacuum gate valves behind and without disturbing or contaminating any of the other optical components of the EUVL system. Upon being vented to atmospheric pressure, the collimator chamber 86 can be disconnected from the closed vacuum gate valves 92, 94. For minimal down time of the EUVL system whenever it is necessary to remove the collimator chamber 86, the collimator chamber can be simply detached from the vacuum gate valves 92, 94 and immediately replaced with another one so that pump-down of the new collimator chamber can be commenced as soon as possible.

### Second Representative Embodiment

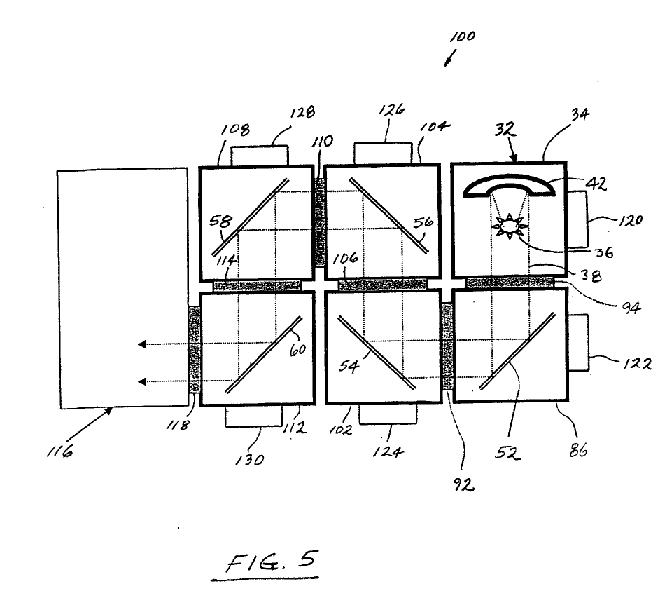

This embodiment is shown in FIG. 5, and is directed to a configuration in which any of the mirrors of the illumination-optical system 100 can be housed in a respective vacuum chamber that is connected to other vacuum chambers by respective vacuum gate valves. Components in FIG. 5 that are similar to corresponding components in the First Representative Embodiment have the same respective reference numbers.

The illumination-optical system 100 of FIG. 5 includes the EUV source 32 contained in the source chamber 34 that also contains the plasma 36 and the collector mirror 42. The source chamber 34 is connected to the collimator chamber 86 by the vacuum gate valve 94. Also shown are the first fly-eye mirror 54, the second fly-eye mirror 56, the first condenser mirror 58, and the second condenser mirror 60. The first fly-eye mirror 54 is housed in a respective vacuum chamber (“FE1 chamber”) 102 connected to the collimator chamber 86 by the vacuum gate valve 92. The second fly-eye mirror 56 is housed in a respective vacuum chamber (“FE2 chamber”) 104 connected to the FE1 chamber 102 by a vacuum gate valve 106. The first condenser mirror 58 is housed in a respective vacuum chamber (“CON1 chamber”) 108 connected to the FE2 chamber 104 by a vacuum gate valve 110. The second condenser mirror 60 is housed in a respective vacuum chamber (“CON2 chamber”) 112 connected to the CON1 chamber 108 by a vacuum gate valve 114. The CON2 chamber 112 is connected to the projection-optics chamber 116 by a vacuum gate valve 118. When all the vacuum gate valves 94, 92, 106, 110, 114, and 118 are open, the illumination beam 38 propagates from the EUV source 32 through each of the chambers to the projection-optics chamber 116.

In the illumination-optical system of FIG. 5, any of the vacuum chambers 34, 86, 102, 104, 108, 112 can be isolated from respective adjacent vacuum chamber(s) by closing the respective vacuum gate valve(s). Upon venting the thus isolated vacuum chamber to atmospheric pressure, access can be gained to the chamber and maintenance can be performed on the mirror(s) inside the chamber. Access to the chambers 34, 86, 102, 104, 108, 112 is obtained through ports 120, 122, 124, 126, 128, 130, respectively. Alternatively, the isolated chamber can be removed and replaced.

Whereas FIG. 5 shows all the mirrors 52, 54, 56, 58, 60 of the illumination-optical system as having respective vacuum chambers 86, 102, 104, 108, 112, this depicted configuration is not intended to be limiting. It may not be necessary to house each of the mirrors individually. For example, it may be more desirable to house the two fly-eye mirrors 54, 56 in a single vacuum chamber and/or the two condenser mirrors 58, 60 in a single vacuum chamber. Furthermore, it may not be necessary to house one or more particular mirrors in an isolatable chamber, especially if the expected maintenance frequency for the mirrors is at a satisfactorily low level to dispense with having to provide for isolation.

An EUVL system including the above-described illumination-optical system can be constructed by assembling various assemblies and subsystems in a manner ensuring that prescribed standards of mechanical accuracy, electrical accuracy, and optical accuracy are met and maintained. To establish these standards before, during, and after assembly, various subsystems (especially the illumination-optical system and projection-optical system) are assessed and adjusted as required to achieve the specified accuracy standards. Similar assessments and adjustments are performed as required of the mechanical and electrical subsystems and assemblies. Assembly of the various subsystems and assemblies includes the creation of optical and mechanical interfaces, electrical interconnections, and plumbing interconnections as required between assemblies and subsystems. After assembling the EUVL system, further assessments, calibrations, and adjustments are made as required to ensure attainment of specified system accuracy and precision of operation. To maintain certain standards of cleanliness and avoidance of contamination, the EUVL system (as well as certain subsystems and assemblies of the system) are assembled in a clean room or the like in which particulate contamination, temperature, and humidity are controlled.

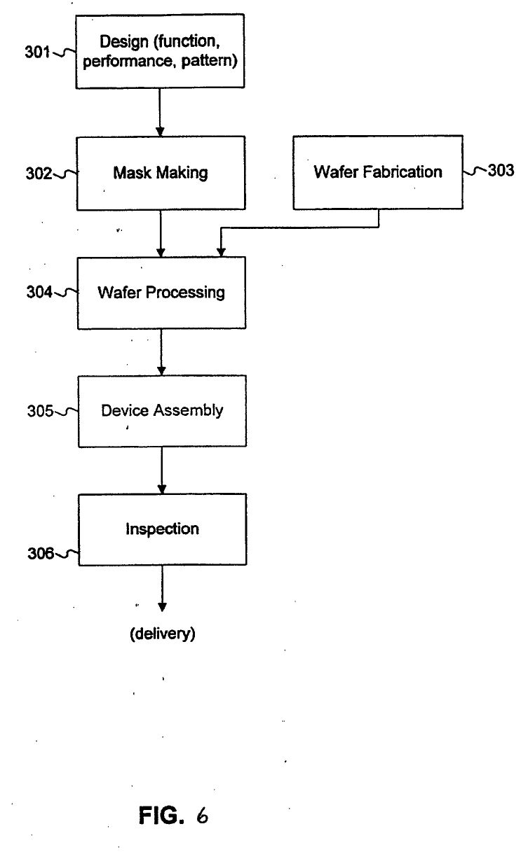

Semiconductor devices can be fabricated by processes including microlithography steps performed using a microlithography system as described above. Referring to FIG. 6, in step 301 the function and performance characteristics of the semiconductor device are designed. In step 302 a reticle defining the desired pattern is designed according to the previous design step. Meanwhile, in step 303, a substrate (wafer) is made and coated with a suitable resist. In step 304 the reticle pattern designed in step 302 is exposed onto the surface of the substrate using the microlithography system. In step 305 the semiconductor device is assembled (including “dicing” by which individual devices or “chips” are cut from the wafer, “bonding” by which wires are bonded to the particular locations on the chips, and “packaging” by which the devices are enclosed in appropriate packages for use). In step 306 the assembled devices are tested and inspected.

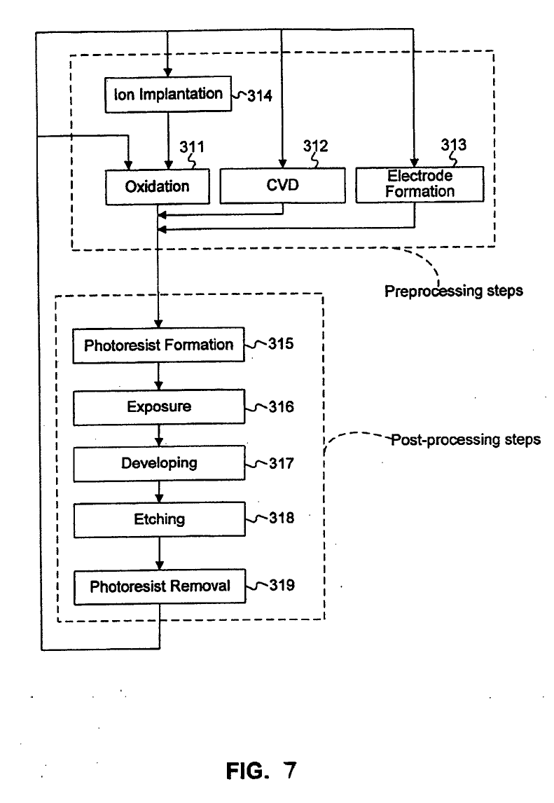

Representative details of a wafer-processing process including a microlithography step are shown in FIG. 7. In step 311 (oxidation) the wafer surface is oxidized. In step 312 (CVD) an insulative layer is formed on the wafer surface. In step 313 (electrode formation) electrodes are formed on the wafer surface by vapor deposition for example. In step 314 (ion implantation) ions are implanted in the wafer surface. These steps 311-314 constitute representative “pre-processing” steps for wafers, and selections are made at each step according to processing requirements.

At each stage of wafer processing, when the pre-processing steps have been completed, the following “post-processing” steps are implemented. A first post-process step is step 315 (photoresist formation) in which a suitable resist is applied to the surface of the wafer. Next, in step 316 (exposure), the microlithography system described above is used for lithographically transferring a pattern from the reticle to the resist layer on the wafer. In step 317 (development) the exposed resist on the wafer is developed to form a usable mask pattern, corresponding to the resist pattern, in the resist on the wafer. In step 318 (etching), regions not covered by developed resist (i.e., exposed material surfaces) are etched away to a controlled depth. In step 319 (photoresist removal), residual developed resist is removed (“stripped”) from the wafer.

Formation of multiple interconnected layers of circuit patterns on the wafer is achieved by repeating the pre-processing and post-processing steps as required. Generally, a set of pre-processing and post-processing steps are conducted to form each layer.

It will be apparent to persons of ordinary skill in the relevant art that various modifications and variations can be made in the system configurations described above, in materials, and in construction without departing from the spirit and scope of this disclosure.

What is claimed is:

1. An optical system for a lithographic exposure apparatus, comprising:
a vacuum chamber having a first vacuum-chamber portion and a second vacuum-chamber portion;
a first optical-system portion contained in the first vacuum-chamber portion and a second optical-system portion contained in the second vacuum-chamber portion; and
a vacuum gate valve separating the first and second vacuum-chamber portions, the vacuum gate valve providing a closable passageway between the first and second vacuum-chamber portions that, when open, allows communication between the first and second vacuum-chamber portions and allows an energy beam to pass from the first optical-system portion to the second optical-system portion via the vacuum gate valve and that, when closed, allows the pressure in the first vacuum-chamber portion to be changed without altering the pressure in the second vacuum chamber portion.

2. The system of claim 1, further comprising an access port in the first vacuum-chamber portion that allows access, from outside the vacuum chamber, to inside the first vacuum-chamber portion.

3. The system of claim 2, wherein the access port is configured to allow passage therethrough of an optical component of the first optical-system portion.

4. The system of claim 2, wherein:
the first optical-system portion includes an optical component requiring periodic maintenance; and
the access port is configured to allow the optical component to be removed from the first vacuum-chamber portion for performance of a maintenance activity on the optical component.

5. The system of claim 1, further comprising a third vacuum-chamber portion and a second vacuum gate valve separating the first and third vacuum-chamber portions, the second vacuum gate valve providing a closable passageway between the first and third vacuum-chamber portions that, when open, allows communication between the first and third vacuum-chamber portions and allows the energy beam to propagate from the third vacuum-chamber portion to the first optical-system portion via the second vacuum gate valve and that, when closed, allows the pressure in the first vacuum-chamber portion to be changed without altering the pressure in the third vacuum chamber portion.

6. The system of claim 5, wherein the third vacuum-chamber portion contains an energy-beam source.

7. The system of claim 6, further comprising an access port in the first vacuum-chamber portion that allows access, from outside the vacuum chamber, to inside the first vacuum-chamber portion.

8. The system of claim 7, wherein:
the first optical-system portion includes an optical component that receives the energy beam from the energy-beam source under a condition in which the optical component requires periodic maintenance; and
the access port is configured to allow the optical component to be removed from the first vacuum-chamber portion for performance of a maintenance activity on the optical component.

9. The system of claim 5, wherein:
the first and second optical-system portions operate in a high-vacuum environment established in the first and second vacuum-chamber portions as well as in the third vacuum-chamber portion; and
the vacuum gate valves, when closed, allow the first vacuum-chamber portion to be vented to atmospheric pressure while preserving the high-vacuum environment in the second and third vacuum-chamber portions.

10. The system of claim 5, wherein the first and second vacuum gate valves are configured to allow detachment of the first vacuum-chamber portion from the second and third vacuum-chamber portions.

11. The system of claim 1, wherein:
the first and second optical-system portions operate in a high-vacuum environment established in the first and second vacuum-chamber portions, respectively; and
the vacuum gate valve, when closed, allows the first vacuum-chamber portion to be vented to atmospheric pressure while preserving the high-vacuum environment in the second vacuum-chamber portion.

12. The system of claim 1, wherein:
the energy beam is an EUV beam;
the optical system is an illumination-optical system; and
the first and second optical-system portions comprise respective EUV-reflective optical elements of the illumination-optical system.

13. The system of claim 1, wherein the vacuum gate valve is configured to allow detachment of the first vacuum-chamber portion from the second vacuum-chamber portion.

14. A lithographic exposure apparatus, comprising an optical system as recited in claim 1.

15. An optical system for a lithographic system that performs lithographic exposures using an energy beam propagating in a vacuum environment, the optical system comprising:
a vacuum chamber having a first vacuum-chamber portion, a second vacuum-chamber portion, and a third vacuum-chamber portion;
an energy-beam source contained in the third vacuum-chamber portion;
a first optical-system portion contained in the first vacuum-chamber portion and configured to receive the energy beam from the energy-beam source;
a second optical-system portion contained in the second vacuum-chamber portion and configured to receive the energy beam from the first optical-system portion;
a first vacuum gate valve separating the first and third vacuum-chamber portions and providing, when open, communication between the first and third vacuum-chamber portions and a propagation pathway for the energy beam from the energy-beam source to the first optical-system portion; and
a second vacuum gate valve separating the first and second vacuum-chamber portions and providing, when open, communication between the first and second vacuum-chamber portions and a propagation pathway for the energy beam from the first optical-system portion to the second optical-system portion;
the first and second vacuum gate valves, when closed, allowing the pressure in the first vacuum-chamber portion to be changed without altering the respective pressures in the second and third vacuum-chamber portions.

16. The system of claim 15, wherein the first vacuum-chamber portion comprises an access port allowing access to the first optical-system portion including whenever the first and second vacuum gate valves are closed.

17. The system of claim 15, wherein the optical system is an illumination-optical system for an extreme ultraviolet (EUV) lithography system.

18. The system of claim 17, wherein:
the illumination-optical system comprises multiple EUV-reflective mirrors; and
the first optical-system portion comprises a collimator mirror of the illumination-optical system.

19. The system of claim 18, wherein the second optical-system portion comprises at least one fly-eye mirror.

20. The system of claim 19, wherein the second optical-system portion further comprises at least one condenser mirror.

21. The system of claim 15, further comprising:
a fourth vacuum-chamber portion;
a third optical-system portion situated in the fourth vacuum-chamber portion and configured to receive the energy beam from the second optical-system portion; and
a third vacuum gate valve separating the second and fourth vacuum-chamber portions and providing, when open, communication between the second and fourth vacuum-chamber portions and a propagation pathway for the energy beam from the second optical-system portion to the third optical-system portion.

22. The system of claim 21, wherein:
the second optical-system portion comprises at least one fly-eye mirror; and
the third optical-system portion comprises at least one condenser mirror.

23. The system of claim 21, wherein each of the first, second, and fourth vacuum-chamber portions includes a respective access port allowing access to the respective optical-system portion including whenever the respective vacuum gate valves are closed.

24. A lithographic system, comprising an optical system as recited in claim 15.

25. An optical system for a lithographic system that performs lithographic exposures using an energy beam propagating in a vacuum environment, the optical system comprising:
a first vacuum chamber;
a second vacuum chamber having a first vacuum-chamber portion and a second vacuum-chamber portion;
an energy-beam source contained in the first vacuum chamber;
a first optical-system portion contained in the first vacuum-chamber portion and configured to receive the energy beam from the energy-beam source;
a second optical-system portion contained in the second vacuum-chamber portion and configured to receive the energy beam from the first optical-system portion;
a first vacuum gate valve separating the first vacuum chamber and the first vacuum-chamber portion and providing, when open, communication between the first vacuum chamber and the first vacuum-chamber portion and a propagation pathway for the energy beam from the energy-beam source to the first optical-system portion; and
a second vacuum gate valve separating the first vacuum-chamber portion and the second vacuum-chamber portion and providing, when open, communication between the first vacuum-chamber portion and the second vacuum-chamber portion and a propagation pathway for the energy beam from the first optical-system portion to the second optical-system portion;
the first and second vacuum gate valves, when closed, allowing the pressure in the first vacuum-chamber portion to be changed without altering the respective pressures in the first vacuum chamber and the second vacuum-chamber portion.

26. The system of claim 25, wherein:
the first vacuum chamber contains an energy-beam source;
the first optical-system portion comprises a first portion of an illumination-optical system of the lithographic system; and
the second optical-system portion comprises a second portion of the illumination-optical system.

27. The system of claim 26, wherein the first optical-system portion comprises an optical element requiring periodic maintenance consequential to the optical element being located proximally, via the first vacuum gate valve, to the energy-beam source.

28. The system of claim 27, wherein the first optical-system portion comprises an access port allowing access to the optical element for maintenance at times including whenever the first and second vacuum gate valves are closed.

29. A lithographic system, comprising an optical system as recited in claim 25.

30. An illumination-optical system (IOS) for an extreme-UV (EUV) lithography system, comprising:
a source chamber;
a vacuum chamber having a first vacuum-chamber portion and a second vacuum-chamber portion;
an EUV-beam source contained in the source chamber, the EUV-beam source producing an illumination beam;
a first IOS portion contained in the first vacuum-chamber portion and configured to receive the illumination beam from the EUV-beam source;
a second IOS portion contained in the second vacuum-chamber portion and configured to receive the illumination beam from the first IOS portion;
a first vacuum gate valve separating the source chamber and the first vacuum-chamber portion and providing, when open, communication between the source chamber and the first vacuum-chamber portion and a propagation pathway for the illumination beam from the EUV-beam source to the first IOS portion; and
a second vacuum gate valve separating the first vacuum-chamber portion and the second vacuum-chamber portion and providing, when open, communication between the first vacuum-chamber portion and the second vacuum-chamber portion and a propagation pathway for the illumination beam from the first IOS portion to the second IOS portion;
the first and second vacuum gate valves, when closed, allowing the pressure in the first vacuum-chamber portion to be changed without altering the respective pressures in the source chamber and the second vacuum-chamber portion.

31. The system of claim 30, wherein:
the EUV-beam source is a plasma-based EUV source; and
the first IOS portion comprises a collimator mirror that collimates the illumination beam from the EUV source.

32. The system of claim 31, wherein:
the second IOS portion comprises at least one fly-eye mirror and at least one condenser mirror; and
the illumination beam propagates from the EUV source, through the first IOS portion, and through the second IOS portion to a reticle.

33. The system of claim 30, wherein the first vacuum-chamber portion comprises an access port allowing access to the first IOS portion for maintenance at times including whenever the first and second vacuum gate valves are closed.

34. The system of claim 30, wherein the first vacuum-chamber portion is detachable from the first and second vacuum gate valves.

35. An EUV lithography system, comprising an illumination-optical system as recited in claim 30.

36. An optical system for a lithographic exposure apparatus, comprising:
first vacuum-chamber means for containing a first optical-system portion at a respective vacuum level;
second vacuum-chamber means for containing a second optical-system portion at a respective vacuum level;
gate means for separating the first and second vacuum-chamber means, for providing a closable passageway between the first and second vacuum-chamber means, and for providing, when open, communication between the first and second vacuum-chamber means and a beam trajectory from the first optical-system portion via the gate means to the second optical-system portion, the gate means further providing, when closed, isolation of the first vacuum-chamber means from the second vacuum-chamber means that allows pressure in the first vacuum-chamber means to be changed without altering pressure in the second vacuum-chamber means.

37. A lithographic exposure apparatus, comprising an optical system as recited in claim 36.

38. In a lithographic exposure apparatus having an optical system contained in a vacuum chamber and having a first optical-system portion and a second optical-system portion, a method for isolating the first optical-system portion relative to the second optical-system portion to allow maintenance access to the first optical-system portion, the method comprising:
situating the first optical-system portion in a first vacuum-chamber portion;
situating a second optical-system portion in a second vacuum-chamber portion that is separated from the first vacuum-chamber portion by a vacuum gate valve that, when open, allows the energy beam to propagate through the open valve from the first optical-system portion to the second optical-system portion; and
closing the vacuum gate valve and, without significantly altering pressure in the second vacuum-chamber portion, venting the first vacuum-chamber portion to a pressure allowing the first vacuum-chamber portion to be opened; and
while keeping the vacuum gate valve closed, opening the first vacuum-chamber portion to gain maintenance access to the first optical-system portion without significantly changing pressure in the second optical-system portion.

39. In an extreme-UV (EUV) lithography apparatus having an EUV-optical system including a first optical-system portion to which access must be gained from time to time, a method for isolating the first optical-system portion relative to a second optical-system portion to allow access to the first optical-system portion, the method comprising:
situating the first optical-system portion in a vacuum-chamber portion that is separated from an upstream chamber by a first vacuum gate valve that, when open, allows an EUV beam to propagate through the open valve from the upstream chamber to the first optical-system portion;
situating the second optical-system portion in a downstream chamber that is separated from the vacuum-chamber portion by a second vacuum gate valve that, when open, allows an EUV beam to propagate through the open valve from the first optical-system portion to the second optical-system portion;
closing the first and second vacuum gate valves and, without significantly altering pressure in the upstream and downstream chambers, venting the vacuum-chamber portion to a pressure allowing opening of the vacuum-chamber portion; and
while keeping the vacuum gate valves closed, opening the vacuum-chamber portion to gain access to the first optical-system portion without significantly changing pressure in the upstream and downstream chambers.

40. The method of claim 39, wherein:
the upstream chamber contains an EUV-beam source;
the EUV-optical system is an illumination-optical system comprising multiple EUV-reflective mirrors; and
the first optical-system portion comprises an EUV-reflective mirror that is most proximal to the EUV-beam source.

41. The method of claim 40, wherein the most proximal EUV-reflective mirror is a collimator mirror.
